(19) United States
(12) Patent Application Publication
(10) Pub. No.: US 2026/0329684 A1
(43) Pub. Date: Oct. 22, 2026

(54) TECHNIQUES TO TRIGGER A FLUSH OF PERSISTENT DATA TO PERSISTENT MEMORY

(71) Applicant: Intel Products IP LLC, Santa Clara, CA (US)

(72) Inventors: Tiffany J. KASANICKY, Longmont, CO (US); Mahesh S. NATU, Folsom, CA (US); Michael D. KINNEY, Woodinville, WA (US); Krzysztof STOJANOWSKI, Vancouver, WA (US); Dan J. WILLIAMS, Banks, OR (US)

(21) Appl. No.: 19/715,304

(22) Filed: Jun. 22, 2026

(51) Int. Cl. G06F 11/07

(52) U.S. Cl. CPC G06F 11/0772; G06F 11/0778

(57) ABSTRACT

Examples include techniques to trigger a flush of persistent data to persistent memory responsive to an indication that an error event will require a computing platform to be reset. The examples can include an operating system (OS) generating a call to a basic input/output system (BIOS) for the computing platform. The call causes the BIOS to write to one or more registers of a processor of the computing platform and enable firmware of the processor to flush the persistent data to the persistent memory and then cause the reset of the computing platform.

### BACKGROUND

Persistent memory devices used by computing platforms are configured to retain content stored to memory media of the persistent memory devices across power cycling. A persistent memory device can indicate to applications hosted by the computing platforms an ability to support certain requirements. For example, the certain requirements described by a specification published by the Compute Express Link (CXL) Consortium to include, but not limited to, the CXL Specification, Revision 4.0, Version 1.0, published on Aug. 13, 2025 (hereinafter referred to as “CXL 4.0”) and/or previous or subsequent versions of the CXL Specification. CXL Specification requirements include a persistent memory device to be configured such that writes targeting persistent memory ranges that have been completed on a CXL data link but are still held in volatile buffers on the persistent memory device, shall be flushed to media following any reset event, a global persistent flush (GPF) event/flow, or a surprise power loss. According to CXL 4.0, a GPF event/flow is a hardware-based mechanism associated with persistent memory that is used to flush cache and memory buffers to a persistence domain. A persistence domain, according to CXL 4.0, is defined as a location that is guaranteed to preserve the data contents across a restart of the device containing the data.

### BRIEF DESCRIPTION OF THE DRAWINGS

FIG. 1 illustrates an example computing platform.

FIG. 2 illustrates an example of additional details of the computing platform.

FIG. 3 illustrates an example ResetSystem( ) Runtime Service.

FIG. 4 illustrates an example reset register format.

FIG. 5 illustrates an example common platform error record format.

FIG. 6 illustrates an example process.

FIG. 7 illustrates an example logic flow.

FIG. 8 illustrates an example server system.

### DETAILED DESCRIPTION

A persistent memory device can indicate to applications hosted by the computing platforms an ability to support a set of requirements in order to be deemed as capable of supporting a persistent domain as defined by CXL 4.0 and/or other CXL Specification revisions. Memory arranged or configured to support the persistent domain is hereinafter referred to as “CXL persistent memory”. CXL persistent memory aware applications can expect that completed write data is preserved across system and device restarts. In real-world scenarios, the data may be held, for example, in processor caches or write buffers of computing platforms for performance reasons. Some CXL guidelines such as, but not limited to, a CXL driver writer's guide published by Intel® Corporation entitled “CXL*Type 3 Memory Device Software Guide”, Revision 1.1, published in August 2024, indicate that a host operating system (OS) software for a computing platform is to ensure that data that applications expect to be stored in a persistent domain (hereinafter referred to as “persistent data”) is flushed as part of a graceful shutdown sequence. However, there are error cases such as, but not limited to, a machine check exception, an unexpected card pull, or an accidental/unexpected power cycle where OS software can be inhibited or unable to perform a successful graceful shutdown sequence and is thus unable to ensure data is flushed to persistent memory. These error cases can possibly result in data loss.

A processor of a computing platform can be configured to provide a hardware-based mechanism to initiate a GPF flow. The hardware-based mechanism to initiate the GPF flow can cause data to be flushed to persistent memory in response to an error condition that can inhibit or prevent a graceful shutdown sequence by OS software (e.g., non-graceful shutdown). The GPF flow can be global in nature and applies to all CXL agents that are part of a cache coherency domain and leads to a system global reset of a computing platform. The GPF flow can be triggered either internally from processor-detected error events or by the computing platform using a dedicated general-purpose input/output (GPIO) pin (e.g., ADR_TRIGGER_N) in response to events such as a power button press. However, current triggering mechanisms for initiating the GPF flow lack a mechanism for the OS or a basic input/output system (BIOS) to directly or manually initiate/trigger the GPF flow.

A technique to indirectly initiate/trigger a GPF flow is for OS software to write to a reset register of a processor accessible by firmware of the processor. The reset register, for example, can be exposed to the OS software via an Advanced Configuration and Power Interface (ACPI) fixed ACPI description table (FADT) as described in a specification published by the Unified Extensible Firmware Interface (UEFI) Forum such as, but not limited to, the ACPI Specification, Release 6.6, published in May of 2025 (“the ACPI specification”). Writes to the reset register of the processor can be trapped to generate a system management interrupt (SMI) which triggers the processor to enter a system management mode (SMM) and allows system firmware (BIOS) to perform a similar graceful shutdown sequence to cause data to be globally flushed to persistent memory as mentioned above for OS software. This technique transfers the responsibility of ensuring data is flushed to persistent memory from OS software to the system firmware (BIOS). However, this indirect technique that uses SMM can be undesirable and is being phased out in future computing platform generations. The indirect technique that uses SMM, can cause all processes to be halted on a computing platform and control of a GPF flow is by system firmware (BIOS) and not by OS software. A preference by most designers of applications that use persistent memory is to have OS software control initiation of a GPF flow rather than the system firmware.

As described in this disclosure, example techniques are described that allow OS software to manually trigger a GPF flow via a ResetSystem( ) runtime service described in the UEFI Specification, Release 2.11, published in November of 2024 by the UEFI forum (“the UEFI specification”). The example techniques can include use of the ResetSystem( ) runtime service in error handling scenarios where a graceful shutdown sequence to flush data to persistent memory is unable to be performed by OS software. Also, the example techniques include the OS software being able to manually trigger the GPF flow in a way to preserve error information by also triggering a crash log flow before data is flushed to persistent memory towards the end of the GPF flow.

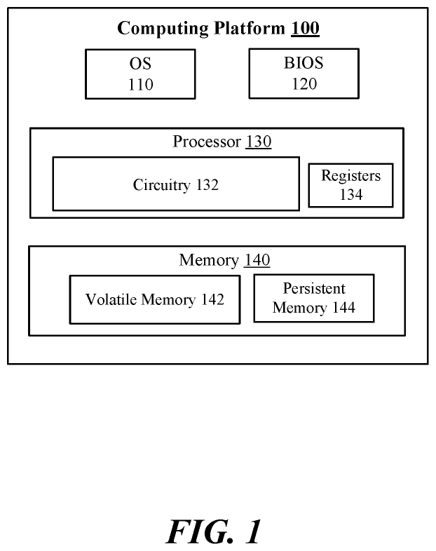

FIG. 1 illustrates an example computing platform 100. Computing platform 100, as shown in FIG. 1, includes an operating system (OS) 110, a basic input/output system (BIOS) 120, a processor 130, or a memory 140. According to some examples, as shown in FIG. 1, processor 130 can include circuitry 132 and registers 134. Circuitry 132 can include one or more processor cores, field programmable gate arrays (FPGAs) or application specific integrated chips (ASICs) arranged as compute circuitry to support applications hosted by computing platform 100 or execute processor firmware. Circuitry 132 can also include processor cache memory (not shown) to temporarily maintain data to be used by compute circuitry (e.g., level 1, 2 or 3 cache). Also, as shown in FIG. 1, processor 130 includes registers 134. Registers 134, for example, can include configuration, management or control registers to configure or manage/control circuitry 132. Also, as described more below, registers 134 can also include registers that can be set to initiate a GPF flow and can be arranged to gather crash log data as part of the initiated GPF flow.

According to some examples, as shown in FIG. 1, memory 140 can include a volatile memory 142 and a persistent memory 144. Memory 140 can include memory devices that include volatile memory 142 and/or persistent memory 144. For example, dual in-line memory modules (DIMMs) or compression attached memory modules (CAMMs) can include volatile memory 142 and/or persistent memory 144. In some examples, the memory devices can be arranged or configured as host managed device memory (HDM) within a type 2 or a type 3 CXL device according to CXL 4.0 or other CXL specifications. Although not shown in FIG. 1, memory 140 can be coupled to elements of processor 130 such as circuitry 132 via communication links operated in compliance with CXL 4.0 or other CXL specifications. Persistent memory 144 can be configured to meet the requirements to store persistent data as described in CXL specifications such as CXL 4.0 in order to support a persistent domain. Volatile memory 142 can include volatile types of memory such as, but not limited to, static random access memory (SRAM) or dynamic random access memory (DRAM). Persistent memory 144 can include battery-backed DRAM or non-volatile types of memory such as, but not limited to NAND flash memory.

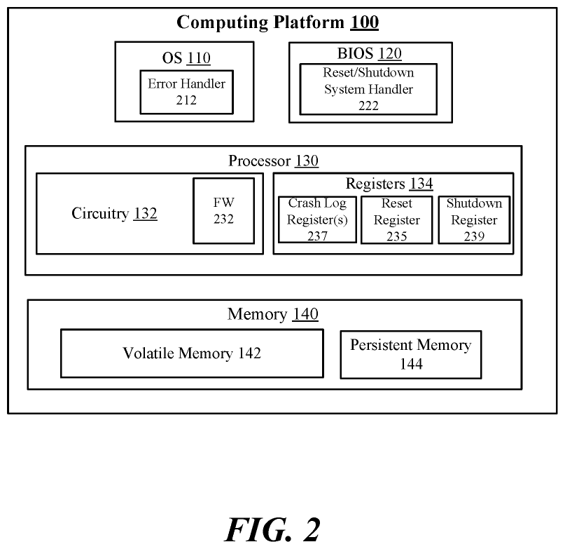

FIG. 2 illustrates an example of additional details of computing platform 100. According to some examples, the additional details include OS 110 including an error handler 212, BIOS 120 including a reset/shutdown system handler 222, circuitry 132 including a firmware (FW) 232. Also, processor 130 can include registers 134 that are accessible/programed by FW 232 of circuitry 132. As shown in FIG. 2, registers can include a reset register 235, one or more crash log register(s) 237 and a shutdown register 239.

In some examples, as described in more detail below, error handler 212 of OS 110 can be arranged to call a ResetSystem( ) runtime service to reset/shutdown system handler 222 of BIOS 120. The ResetSystem( ) runtime service with a vendor-specific globally unique identifier (GUID) can identify a reset type to reset/shutdown system handler 222. The reset type can include a warm reset, a cold reset, a GPF reset, or system shutdown. According to some examples, if the call of the ResetSystem( ) runtime service is responsive to an error case such as a machine check exception (MCE), an unexpected card pull, or an accidental/unexpected power cycle of computing platform 100, and the reset type is a GPF reset, OS 110 is capable of directly initiating a GPF flow by indicating in the vender-specific GUID that the reset is for a GPF. Responsive to ResetSystem( ) runtime service indicating a GPF reset, reset/shutdown system handler 222 can work with FW 232 to initiate a crash log to be stored initially to crash log register(s) 237 and set bits of reset register 235 to indicate that a hardware (HW) GPF is to be implemented after the crash log is gathered/stored to crash log register(s) 237. According to some examples, error conditions gathered/stored to crash log register(s) 237 can be used to generate a common platform error record (CPER) as described in the ACPI specification.

In some examples, OS 110 can call a service that indicates a full shutdown or power down of computing platform 100 rather than a reset. For these examples, the service indicating a full shutdown or power down can be called to rest/shutdown system handler 222 of BIOS 120 to cause at least one bit in shutdown register 239 to be set to indicate a shutdown is to occur. The shutdown, for example, can be similar to a system management interrupt (SMI), for example, via OS 110's exposure to a fixed ACPI description table (FADT). The shutdown, for example, can occur where data was not in flight during processing and a GPF flow is not required to meet CXL specification requirement for use of persistent memory. Also, the action can be responsive to a planned shutdown (e.g., power management/conservation activity) and thus no crash log information needs to be gathered during this type of shutdown.

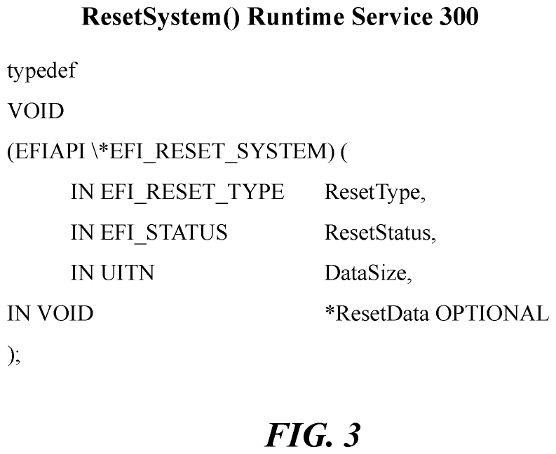

FIG. 3 illustrates an example ResetSystem Runtime Service 300. Example ResetSystem( ) Runtime Service 300 is an example format for a runtime service called by an OS or an error handler of the OS such as error handler 212 of OS 110. The runtime service can be called to a reset error handler of a BIOS such as reset/shutdown system handler 222 of BIOS 120. According to some examples, in the IN EFI_RESET_TYPE field of example ResetSystem Runtime Service 300, a reset type as defined in the UEFI specification for “EfiRestCold”, EfiResetWarm”, “EfiResetShutdown”, or “EfiResetPlatformSpecific” can be called for a cold rest, a warm reset, a shutdown, or GPF, respectively. Also for these examples, the IN EFI_STATUS field can indicate an error condition that caused error handler 212 to issue the runtime service to initiate a reset or shutdown. For example, a machine check error. Also for these examples, the IN UITN field can indicate a data size, in bytes of ResetData and ResetData can include the vender-specific GUID that can indicate, for example, that the reset is to be for a GPF (e.g., of computing platform 100).

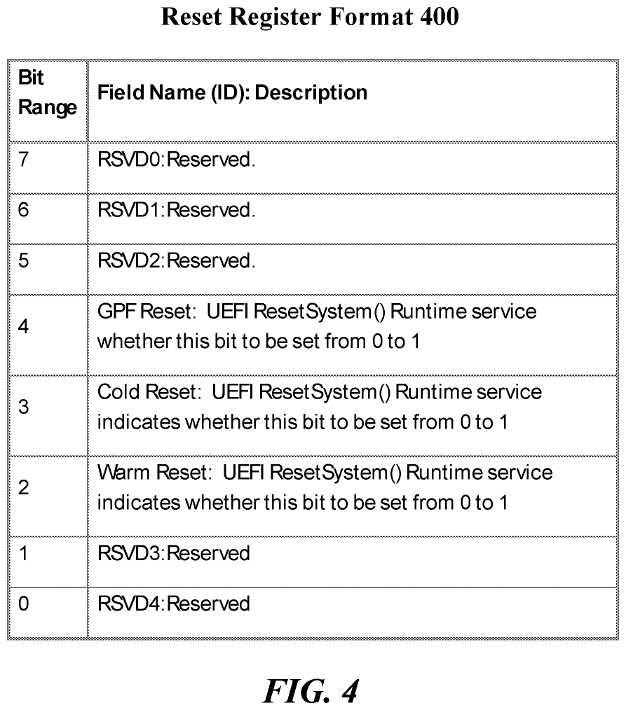

FIG. 4 illustrates an example reset register format 400. In some examples, reset register format 400 provides an example of a format for a register such as reset register 235 that can be maintained in processor 130 and can have a 0-7 bit range of bits that can be set to a value of 0 or 1. Reset register 235 can be configured as a reset control register for processor 130. In some examples, the bits of reset register 235 can be selectively set by reset/shutdown system handler 222 responsive to a ResetSystem( ) runtime service call made by error handler 212 that was generated due to an error condition or event. As shown in FIG. 4, bit 2 can be set to 1 to indicate a warm reset, bit 3 can be set to 1 to indicate a cold reset, and bit 4 can be set to 1 to indicate a GPF reset. Bits 7-5 and 1-0 can be reserved.

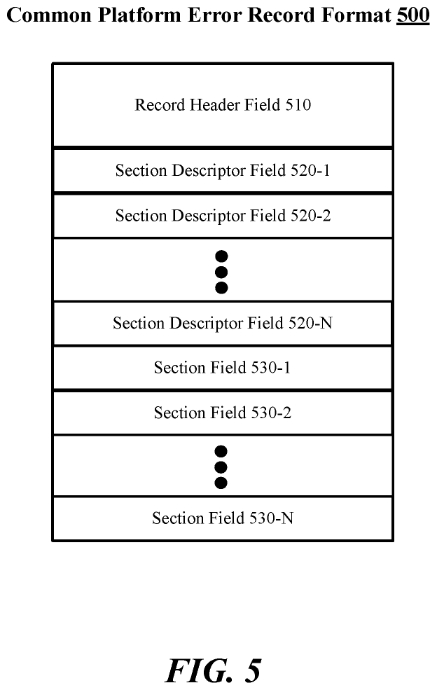

FIG. 5 illustrates an example common platform error record format 500. According to some examples, common platform error record format 500 can be arranged in accordance with the UEFI specification and can include information pulled from one or more crash log registers such as crash log register(s) 237 of registers 134 included in processor 130 following a GPF reset of computing platform 100. For these examples, record header field 510 can include information to uniquely identify a hardware error record of the computing system, the record header field can also indicate a notification type that holds a pre-assigned GUID value indicating that the common platform error record (CPER) in the example format of common platform error record format 500 was generated in association with an error event notification type, such as, but not limited to, a machine check exception (MCE). Section descriptor field 520-1 to 520-N, where “N” represent any positive integer >1, can describe locations in the of respective section fields 520-1 to 530-N that can include error information such as error status information or error type information that provides contextual information relevant to the error that caused the CPER to be generated.

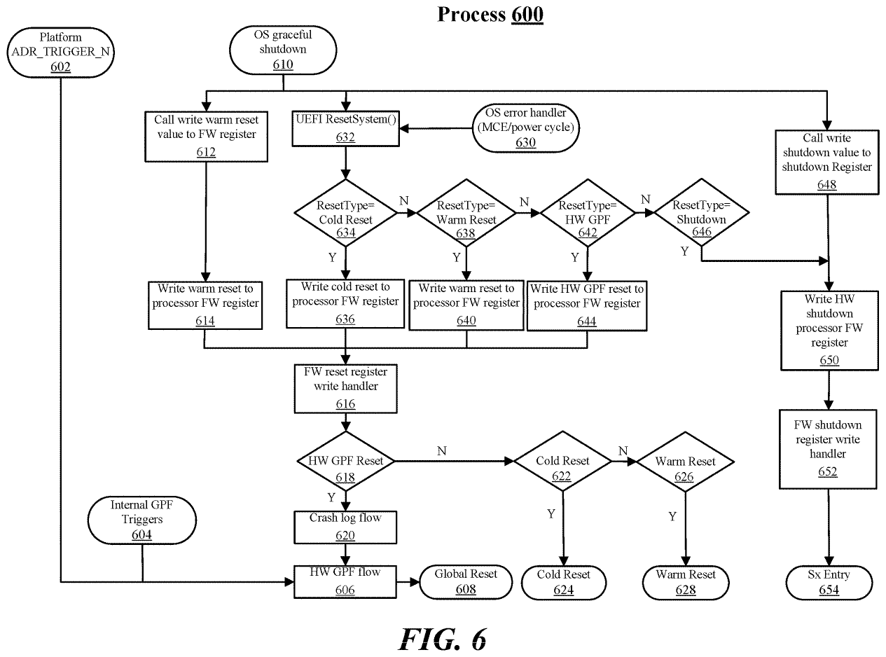

FIG. 6 illustrates an example process 600. According to some examples, process 600 shows example process to reset or shut down a system such as computing platform 100. For these examples, elements of computing platform 100 as shown in FIGS. 1-2 and described above can implement at least portions of process 600. Also, aspects of example ResetSystem( ) runtime service 300, reset register format 400 or common platform error record format 500 as shown in FIGS. 3-5 and described above can be utilized by these elements of computing platform 100 to implement at least portions of process 600. Although process 600 is not limited to implementation by these elements of computing platform 100 or to runtime service or register formats mentioned above.

According to some examples, at block 602, a dedicated general-purpose input/output (GPIO) pin associated with ADR_TRIGGER_N can be one example way to initiate a reset of computing platform 100. For these examples, the dedicated GPIO pin can be triggered in response to a power button press for a power source to computing platform 100. This type of initiation of a reset is not due to an error and a crash flow log may not be necessary.

In some examples, at block 604, circuitry of computing platform 100 such as circuitry 132 can cause internal GPF triggers that internally initiates a HW GPF flow to cause persistent data to be flushed to persistent memory 144.

According to some examples, at block 606, the HW GPF flow is implemented to cause data to be flushed to persistent memory 144.

In some examples, at block 608, computing platform 100 can implement a global reset once the HW GPF flow is complete.

According to some examples, at block 610, an OS graceful shutdown can be initiated. For these examples, the OS graceful shutdown can be initiated by OS 110 and can be responsive to an error condition in computing platform 100. As shown in FIG. 6, process 600 can move to block 612 to follow a warm reset path or block 632 to follow one of a cold, warm HW GPF or shutdown reset path. Moving to block 612 is described first, the other paths are described later.

In some examples, at block 612, OS 110 can be exposed to a reset register via a FADT and OS 110 can write a call to BIOS 120 to cause BIOS 120 to write a warm reset value to reset register 235.

According to some examples, at block 614, reset/shutdown system handler 222 can cause the warm reset value to be written to reset register 235 of registers 134. For example, a value of 1 is written to bit 2 when reset register 235 uses reset register format 400 to indicate a warm reset. Meanwhile, the value maintained in bits 4-2 of reset register 235 can have a value of 0.

In some examples, at block 616, FW 232 implemented by circuitry 132 of processor 130 can serve as a FW reset register write handler to facilitate implementation of the warm reset.

According to some examples, at decision block 618, since a warm reset is being implemented, process 600 moves to decision block 622.

In some examples, at decision block 622, since a warm reset is being implemented, process 600 moves to decision block 626 and FW 232 facilitates a warm reset of computing platform 100 at block 628. For these examples, the warm reset at block 628 can include maintaining data stored in registers 134 for use after the warm reset. This data can be used to evaluate what may have caused the error condition that initiated the OS graceful shutdown.

According to some examples, at block 630, an error that does not enable OS 110 to implement a graceful shutdown such as an MCE or unexpected power cycle can cause error handler 212 of OS 110 to call a ResetSystem( ) runtime service in the format of ResetSystem( ) runtime service 300. For these examples, the ResetSystem( ) runtime service can indicate whether a cold, warm HW GPF or shutdown reset is to occur.

In some examples, at block 632, reset/shutdown system handler 222 can receive the call for ResetSystem( ) runtime service that indicates one of a cold, warm HW GPF or shutdown reset is to occur.

According to some examples, at decision block 634, ResetSystem( ) runtime service indicates a cold reset, so process 600 moves to block 636. For these examples, at block 636, reset/shutdown system handler 222 of BIOS 120 can cause the cold reset value to be written to reset register 235 of registers 134. For example, a value of 1 is written to bit 3 when reset register 235 uses reset register format 400 to indicate a cold reset. Meanwhile, the value maintained in bits 4 and 2 of reset register 235 can have a value of 0.

In some examples, at block 616, since this is a cold reset path for process 600, FW 232 can serve as a FW reset register write handler to facilitate implementation of the cold reset.

According to some examples, at decision block 618, since a cold reset is being implemented, process 600 moves to decision block 622 and FW 232 facilitates a cold reset of computing platform 100 at block 624. For these examples, the cold reset at block 624 can include resetting on or more registers included in registers 134 to default values following the reset of computing platform 100. In other words, data is not maintained in these one or more registers after a cold reset of computing platform 100.

According to some examples, at decision block 634, ResetSystem( ) runtime service indicates a warm reset, so process 600 moves to block 638. For these examples, at block 640, similar to block 614 mentioned above, reset/shutdown system handler 222 of BIOS 120 can cause the warm reset value to be written to reset register 235 of registers 134. For example, a value of 1 is written to bit 2 when reset register 235 uses reset register format 400 to indicate a warm reset. Meanwhile, the value maintained in bits 4-3 of reset register 235 can have a value of 0.

In some examples, at block 616, since this is a warm reset path for process 600, FW 232 can serve as a FW reset register write handler to facilitate implementation of the warm reset.

According to some examples, at decision block 618, since a warm reset is being implemented, process 600 moves to decision block 626 and FW 232 facilitates a warm reset of computing platform 100 at block 628.

According to some examples, at decision block 642, ResetSystem( ) runtime service indicates a HW GPF, so process 600 moves to block 644. For these examples, at block 644, reset/shutdown system handler 222 of BIOS 120 can cause the HW GPF value to be written to reset register 235 of registers 134. For example, a value of 1 is written to bit 4 when reset register 235 uses reset register format 400 to indicate a HW GPF reset. Meanwhile, the value maintained in bits 3-2 of reset register 235 can have a value of 0.

In some examples, at block 616, since this is a HW GPF reset path for process 600, FW 232 can serve as a FW reset register write handler to facilitate implementation of the HW GPF reset.

According to some examples, at decision block 618, since a HW GPF reset is being implemented, process 600 moves to block 620 and FW 232 facilitates gathering of crash log information from crash log register(s) 237 to generate, for example, a common platform error record (CPER) in the example format of common platform error record format 500.

In some examples, at decision block 618, for a HW GPF initiated by OS error handler 212 via a ResetSystem( ) runtime service call, the HW GPF flow is implemented to cause persistent data to be flushed to persistent memory 144 and then, at block 608 a global reset is implemented once the HW GPF flow is complete.

According to some examples, at decision block 646, ResetSystem( ) runtime service indicates a shutdown reset type, so process 600 moves to block 650 to represent a first shutdown flow path. A second shutdown path can be responsive to an OS graceful shutdown via block 610 that does not require a warm, cold or HW GPF reset. For these two shutdown paths, at block 650, reset/shutdown system handler 222 of BIOS 120 can cause the shutdown value to be written to shutdown register 239 of registers 134. For example, a value of 1 can be written to a bit of shutdown register 239 to indicate a shutdown reset.

In some examples, at block 652, FW 232 facilitates a shutdown reset of computing platform 100. For these examples, an Sx entry at block 654 can include powering down computing platform 100 completely (e.g., S5) or entering a sleeping system power state (e.g., S4). Block 654 completes the various reset or shutdown paths for process 600.

Included herein is a logic flow representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware examples, a logic flow can be implemented by computer executable instructions stored on at least one non-transitory computer readable medium or machine readable medium, such as an optical, magnetic or semiconductor storage. The examples are not limited in this context.

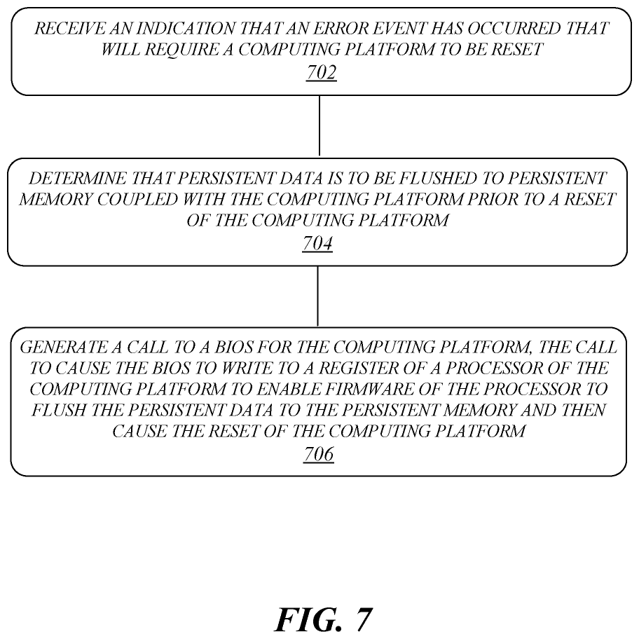

FIG. 7 illustrates an example flow 700. In some examples, flow 700 provides an example of an OS to trigger a flush of persistent data to persistent memory responsive to an indication that an error event will require a computing platform to be reset. For these examples, flow 700 can be implemented by elements or components of computing platform 100 as shown in FIGS. 1 and 2 such as, but not limited to, logic and/or features of OS 110 (e.g., error handler 212. The computing platform can also include a BIOS such as BIOS 120 with logic/and or features (e.g., reset/shutdown system handler 222) and a processor such as processor 130 having circuitry (e.g., circuitry 132) to execute firmware (e.g., FW 232) that can facilitate the flushing of persistent data to persistent memory (e.g., persistent memory 144) and resetting the computing platform based on the setting of bits of registers maintained by the processor (e.g., reset register 235 of registers 134). The bits set responsive to a call from the OS to the BIOS.

According to some examples, flow 700 at block 702 is to receive an indication that an error event has occurred that will require the computing platform to be reset. For these examples, error handler 212 of OS 110 can receive the indication of the error event. The error event, for example, can be an MCE or unexpected power cycle of computing platform 100.

In some examples, flow 700 at block 704 is to determine that persistent data is to be flushed to persistent memory coupled with the computing platform prior to a reset of the computing platform. For these examples, OS 110 can determine the need to flush the persistent data based on computing platform 100 having persistent memory 144 configured according to CXL 4.0 to support a persistent domain that preserve completed write data (e.g., from processor 130's cache or in write buffers of memory 140) prior to resetting computing platform 100.

According to some examples, flow 700 at block 706 is to generate a call to a BIOS for the computing platform, the call to cause the BIOS to write to one or more registers of a processor of the computing platform to enable firmware of the processor to flush the persistent data to the persistent memory and then cause the reset of the computing platform. For these examples, the call can be a ResetSystem( ) Runtime Service that includes information to cause logic and/or features of BIOS 120 (e.g., reset/shutdown system handler 222) to write to reset register 235 of registers 134 maintained by processor 130 to cause FW 232 to flush the persistent data to persistent memory 144 and then cause the reset of computing platform 100.

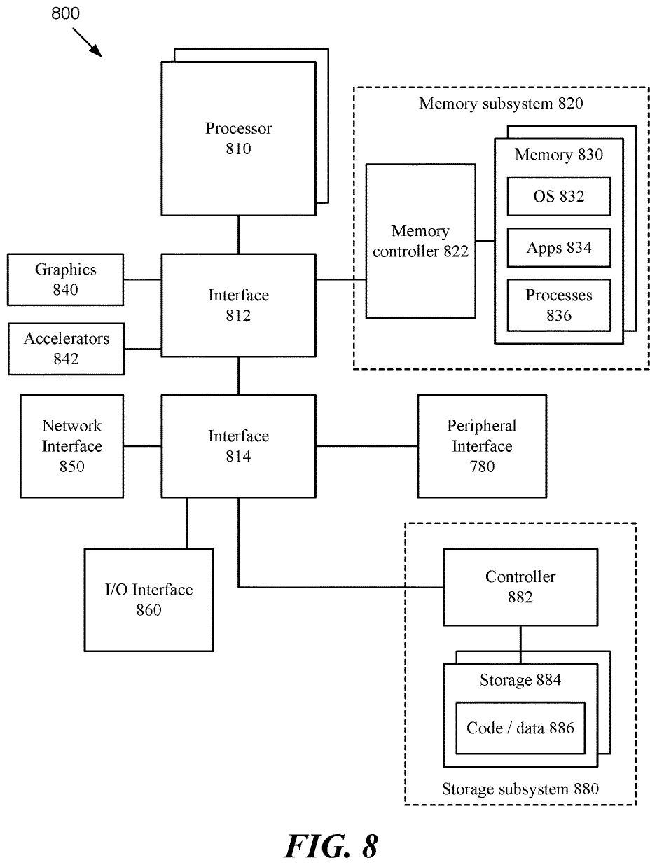

FIG. 8 illustrates an example server system 800. In some examples, server system 800 can be representative of a server or computing platform such as computing platform 100. Server system 800 includes processor 810, which can be a type of circuitry to provide processing, operation management, and execution of instructions for server system 800. Processor 810 can include any type of microprocessor, CPU, GPU, XPU, processing core, or other processing hardware to provide processing for server system 800, or a combination of processors. An XPU can include one or more of: a CPU, a GPU, general purpose GPU (GPGPU), and/or other processing units (e.g., accelerators or programmable or fixed function FPGAs). Processor 810 controls the overall operation of server system 800, and can be or include, one or more programmable general-purpose or special-purpose microprocessors, digital signal processors (DSPs), programmable controllers, ASICs, programmable logic devices (PLDs), or the like, or a combination of such devices. Processor 810 can include multiple processors and multiple processors can be embodied as processor sockets.

In one example, server system 800 includes interface 812 coupled to processor 810, which can represent a higher speed interface or a high throughput interface for system components, such as memory subsystem 820 or graphics interface components 840, or accelerators 842. Interface 812 represents an interface circuit, which can be a standalone component or integrated onto a processor die. Where present, graphics interface 840 interfaces to graphics components for providing a visual display to a user of server system 800. In one example, graphics interface 840 generates a display based on data stored in memory 830 or based on operations executed by processor 810 or both. In one example, graphics interface 840 generates a display based on data stored in memory 830 or based on operations executed by processor 810 or both.

Accelerators 842 can be a programmable or fixed function offload engine that can be accessed or used by a processor 810. For example, an accelerator among accelerators 842 can provide data compression (DC) capability, cryptography services such as public key encryption (PKE), cipher, hash/authentication capabilities, decryption, or other capabilities or services. In some cases, accelerators 842 can be integrated into a CPU socket (e.g., a connector to a motherboard or circuit board that includes a CPU and provides an electrical interface with the CPU). For example, accelerators 842 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 842 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 820 represents the main memory of server system 800 and provides storage for code to be executed by processor 810, or data values to be used in executing a routine. Memory subsystem 820 can include one or more memory devices 830 such as read-only memory (ROM), flash memory, one or more varieties of random access memory (RAM) such as DRAM, or other memory devices, or a combination of such devices. Memory 830 stores and hosts, among other things, operating system (OS) 832 to provide a software platform for execution of instructions in server system 800. Additionally, applications 834 can execute on the software platform of OS 832 from memory 830. Applications 834 represent programs that have their own operational logic to perform execution of one or more functions. Processes 836 represent agents or routines that provide auxiliary functions to OS 832 or one or more applications 834 or a combination. OS 832, applications 834, and processes 836 provide software logic to provide functions for server system 800. In one example, memory subsystem 820 includes memory controller 822, which is a memory controller to generate and issue commands to memory 830. It will be understood that memory controller 822 could be a physical part of processor 810 or a physical part of interface 812. For example, memory controller 822 can be an integrated memory controller, integrated onto a circuit with processor 810.

Applications 834 and/or processes 836 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 832 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

While not specifically illustrated, it will be understood that server system 800 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a CXL bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, server system 800 includes interface 814, which can be coupled to interface 812. In one example, interface 814 represents an interface circuit, which can include standalone components and integrated circuitry. In one example, multiple user interface components or peripheral components, or both, couple to interface 814. Network interface 850 provides server system 800 the ability to communicate with remote devices (e.g., servers, workstations, or other computing devices) over one or more networks. Network interface 850 can include an Ethernet adapter, wireless interconnection components, cellular network interconnection components, USB (universal serial bus), CXL/PCIe, or other wired or wireless standards-based or proprietary interfaces. Network interface 850 can transmit data to a device that is in the same data center or rack or a remote device, which can include sending data stored in memory (e.g., send a FAM mapped test list). Network interface 850 can receive data (e.g., receive a FAM mapped test list) from a remote device, which can include storing received data into memory. In some examples, packet processing device or network interface device 850 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, server system 800 includes one or more input/output (I/O) interface(s) 860. I/O interface 860 can include one or more interface components through which a user interacts with server system 800. Peripheral interface 870 can include any hardware interface not specifically mentioned above. Peripherals refer generally to devices that connect dependently to server system 800.

In one example, server system 800 includes storage subsystem 880 to store data in a nonvolatile manner. In one example, in certain system implementations, at least certain components of storage 880 can overlap with components of memory subsystem 820. Storage subsystem 880 includes storage device(s) 884, which can be or include any conventional medium for storing large amounts of data in a nonvolatile manner, such as one or more magnetic, solid state, or optical based disks, or a combination. Storage 884 holds code or instructions and data 886 in a persistent state (e.g., the value is retained despite interruption of power to server system 800). Storage 884 can be generically considered to be a “memory,” although memory 830 is typically the executing or operating memory to provide instructions to processor 810. Whereas storage 884 is nonvolatile, memory 830 can include volatile memory (e.g., the value or state of the data is indeterminate if power is interrupted to server system 800). In one example, storage subsystem 880 includes controller 882 to interface with storage 884. In one example controller 882 is a physical part of interface 814 or processor 810 or can include circuits or logic in both processor 810 and interface 814.

A volatile memory can include memory whose state (and therefore the data stored in it) is indeterminate if power is interrupted to the device. A non-volatile memory (NVM) device can include a memory whose state is determinate even if power is interrupted to the device.

In some examples, server system 800 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, CXL, HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., an NVMe device can operate in a manner consistent with the NVMe 2.3 or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, server system 800 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

One or more aspects of at least one example can be implemented by representative instructions stored on a machine-readable medium which represents various logic within the processor, which when read by a machine causes the machine to fabricate logic to perform the techniques described herein. Such representations, known as “IP cores” can be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, various examples also include non-transitory, tangible machine-readable media containing instructions or containing design data, such as Hardware Description Language (HDL), which defines structures, circuits, apparatuses, processors and/or system features described herein. Such examples may also be referred to as program products.

In some cases, an instruction converter can be used to convert an instruction from a source instruction set to a target instruction set. For example, the instruction converter can translate (e.g., using static binary translation, dynamic binary translation including dynamic compilation), morph, emulate, or otherwise convert an instruction to one or more other instructions to be processed by the core. The instruction converter can be implemented in software, hardware, firmware, or a combination thereof. The instruction converter may be on processor, off processor, or part on and part off processor.

Various examples can be implemented using hardware elements, software elements, or a combination of both. In some examples, hardware elements can include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements can include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements can vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

The following examples pertain to additional examples of technologies disclosed herein.
Example 1. An example processor can include a plurality of registers to include a reset register, and circuitry configured to execute firmware. The firmware can receive an indication that a BIOS for a computing platform hosting the processor has set at least one bit in the reset register to indicate persistent data is to be flushed to persistent memory coupled with the computing platform. The BIOS can set the at least one bit responsive to a call from an OS for the computing platform. The call can be generated by the OS in response to an error event that will require the computing platform to be reset. The firmware can also cause the persistent data to be flushed to the persistent memory and cause the computing platform to be reset.
Example 2. The processor of example 1, the plurality of registers can also include one or more crash log registers. The firmware can be directed by the BIOS to gather crash log data from the one or more crash log registers prior to causing the computing platform to be reset.
Example 3. The processor of example 2, the firmware can generate, using the gathered crash log data, a CPER in a format described in an UEFI specification.
Example 4. The processor of example 1, the call from the OS can include a ResetSystem( ) Runtime Service in a format described in an UEFI specification. The ResetSystem( ) Runtime Service can include information to cause the BIOS to set the at least one bit in the reset register to indicate the persistent data is to be flushed to the persistent memory before the reset of the computing platform.
Example 5. The processor of example 1, the persistent memory can be configured according to a CXL specification and can be configured to support a persistent domain.
Example 6. The processor of example 5, the persistent memory can include non-volatile memory included in a type 2 or a type 3 CXL device configured as HDM.
Example 7. The processor of example 1, the error event can be a machine check exception.
Example 8. An example method can include receiving, at an OS for a computing platform, an indication that an error event has occurred that will require the computing platform to be reset;. The method can also include determining that persistent data is to be flushed to persistent memory coupled with the computing platform prior to a reset of the computing platform. The method can also include generating, by the OS, a call to a BIOS for the computing platform. The call can cause the BIOS to write to a register of a processor of the computing platform to enable firmware of the processor to flush the persistent data to the persistent memory and then cause the reset of the computing platform.
Example 9. The method of example 8, the call to the BIOS to write to the register of the processor can also cause the BIOS to direct the firmware of the processor to gather crash log data prior to the reset of the computing platform.
Example 10. The method of example 9, the crash log data can be gathered from one or more registers of the processor to generate a CPER in a format described in an UEFI specification.
Example 11. The method of example 8, the call to the BIOS to write to registers of the processor can also include a ResetSystem( ) Runtime Service in a format described in an UEFI specification. The ResetSystem( ) Runtime Service can include information to cause the BIOS to write to registers of a processor of the computing platform to enable firmware of the processor to flush the persistent data to the persistent memory and then cause the reset of the computing platform.
Example 12. The method of example 8, the persistent memory can be configured according to a CXL specification and can be configured to support a persistent domain.
Example 13. The method of example 12, the persistent memory can include non-volatile memory included in a type 2 or a type 3 CXL device configured as HDM.
Example 14. The method of example 8, the error event can be a machine check exception.
Example 13. An example at least one machine readable medium can include a plurality of instructions that in response to being executed by a system can cause the system to carry out a method according to any one of examples 7 to 12.
Example 14. An apparatus can include means for performing the methods of any one of examples 7 to 12.
Example 15. An example at least one machine readable medium can include a plurality of instructions that in response to being executed by an OS of a computing platform, can cause the OS to receive an indication that an error event has occurred that will require the computing platform to be reset. The instructions can also cause the OS to determine that persistent data is to be flushed to persistent memory coupled with the computing platform prior to a reset of the computing platform. The instructions can also cause the OS to generate a call to a BIOS for the computing platform. The call can cause the BIOS to write to a register of a processor of the computing platform to enable firmware of the processor to flush the persistent data to the persistent memory and then cause the reset of the computing platform.
Example 16. The at least one machine readable medium of example 15, the call to the BIOS to write to the register of the processor can also cause the BIOS to direct the firmware of the processor to gather crash log data prior to the reset of the computing platform.
Example 17. The at least one machine readable medium of example 16, the crash log data can be gathered from one or more registers of the processor to generate a CPER in a format described in an UEFI specification.
Example 18. The at least one machine readable medium of example 15, the call to the BIOS to write to registers of the processor can include a ResetSystem( ) Runtime Service in a format described in an UEFI specification. The ResetSystem( ) Runtime Service can include information to cause the BIOS to write to registers of a processor of the computing platform to enable firmware of the processor to flush the persistent data to the persistent memory and then cause the reset of the computing platform.
Example 19. The at least one machine readable medium of example 15, the persistent memory can be configured according to a CXL specification and can be configured to support a persistent domain.
Example 20. The at least one machine readable medium of example 19, the persistent memory can include non-volatile memory included in a type 2 or a type 3 CXL device configured as HDM.
Example 21. The at least one machine readable medium of example 15, the error event can be a machine check exception.
Example 22. An example computing platform can include an OS, a BIOS, and a processor. The processor can be configured to include a plurality of registers to include a reset register and circuitry configured to execute firmware. The firmware can receive an indication that BIOS has set at least one bit in the reset register to indicate persistent data is to be flushed to persistent memory coupled with the computing platform. The BIOS can be set the at least one bit responsive to a call from the OS. The call can be generated by the OS in response to an error event that will require the computing platform to be reset. The firmware can also cause the persistent data to be flushed to the persistent memory and cause the computing platform to be reset.
Example 23. The computing platform of example 22, the plurality of registers can also include one or more crash log registers. The firmware can be directed by the BIOS to gather crash log data from the one or more crash log registers prior to causing the computing platform to be reset.
Example 24. The computing platform of example 23, the firmware can generate, using the gathered crash log data, a CPER in a format described in an UEFI specification.
Example 25. The computing platform of example 22, the call from the OS can include a ResetSystem( ) Runtime Service in a format described in an UEFI specification. The ResetSystem( ) Runtime Service can include information to cause the BIOS to set the at least one bit in the reset register to indicate the persistent data is to be flushed to the persistent memory before the reset of the computing platform.
Example 26. The computing platform of example 22, the persistent memory can be configured according to a CXL specification and can be configured to support a persistent domain.
Example 27. The computing platform of example 26, the persistent memory can include non-volatile memory included in a type 2 or a type 3 CXL device configured as HDM.
Example 28. The computing platform of example 22, the error event can be a machine check exception.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A processor comprising:
a plurality of registers to include a reset register; and
circuitry configured to execute firmware, the firmware to:
receive an indication that a basic input/output system (BIOS) for a computing platform hosting the processor has set at least one bit in the reset register to indicate persistent data is to be flushed to persistent memory coupled with the computing platform, the BIOS to set the at least one bit responsive to a call from an operating system (OS) for the computing platform, the call generated by the OS in response to an error event that will require the computing platform to be reset;
cause the persistent data to be flushed to the persistent memory; and
cause the computing platform to be reset.

2. The processor of claim 1, wherein the plurality of registers also include one or more crash log registers, and wherein the firmware is directed by the BIOS to gather crash log data from the one or more crash log registers prior to causing the computing platform to be reset.

3. The processor of claim 2, wherein the firmware is to generate, using the gathered crash log data, a common platform error record (CPER) in a format described in a Unified Extensible Firmware Interface (UEFI) specification.

4. The processor of claim 1, wherein the call from the OS includes a ResetSystem( ) Runtime Service in a format described in a Unified Extensible Firmware Interface (UEFI) specification, the ResetSystem( ) Runtime Service to include information to cause the BIOS to set the at least one bit in the reset register to indicate the persistent data is to be flushed to the persistent memory before the reset of the computing platform.

5. The processor of claim 1, wherein the persistent memory is configured according to a Compute Express Link (CXL) specification and is configured to support a persistent domain.

6. The processor of claim 5, wherein the persistent memory includes non-volatile memory included in a type 2 or a type 3 CXL device configured as host managed device memory (HDM).

7. The processor of claim 1, wherein the error event comprises a machine check exception.

8. A method comprising:
receiving, at an operating system (OS) for a computing platform, an indication that an error event has occurred that will require the computing platform to be reset;
determining that persistent data is to be flushed to persistent memory coupled with the computing platform prior to a reset of the computing platform; and
generating, by the OS, a call to a basic input/output system (BIOS) for the computing platform, the call to cause the BIOS to write to a register of a processor of the computing platform to enable firmware of the processor to flush the persistent data to the persistent memory and then cause the reset of the computing platform.

9. The method of claim 8, wherein the call to the BIOS to write to the register of the processor also causes the BIOS to direct the firmware of the processor to gather crash log data prior to the reset of the computing platform.

10. The method of claim 8, wherein the call to the BIOS to write to registers of the processor includes a ResetSystem( ) Runtime Service in a format described in a Unified Extensible Firmware Interface (UEFI) specification, the ResetSystem( ) Runtime Service to include information to cause the BIOS to write to registers of a processor of the computing platform to enable firmware of the processor to flush the persistent data to the persistent memory and then cause the reset of the computing platform.

11. The method of claim 8, wherein the persistent memory is configured according to a Compute Express Link (CXL) specification to support a persistent domain and includes non-volatile memory included in a type 2 or a type 3 CXL device configured as host managed device memory (HDM).

12. At least one machine readable medium comprising a plurality of instructions that in response to being executed by an operating system (OS) of a computing platform, causes the OS to:
receive an indication that an error event has occurred that will require the computing platform to be reset;
determine that persistent data is to be flushed to persistent memory coupled with the computing platform prior to a reset of the computing platform; and
generate a call to a basic input/output system (BIOS) for the computing platform, the call to cause the BIOS to write to a register of a processor of the computing platform to enable firmware of the processor to flush the persistent data to the persistent memory and then cause the reset of the computing platform.

13. The at least one machine readable medium of claim 12, wherein the call to the BIOS to write to the register of the processor also causes the BIOS to direct the firmware of the processor to gather crash log data prior to the reset of the computing platform.

14. The at least one machine readable medium of claim 13, wherein the crash log data is to be gathered from one or more registers of the processor to generate a common platform error record (CPER) in a format described in a Unified Extensible Firmware Interface (UEFI) specification.

15. The at least one machine readable medium of claim 12, wherein the call to the BIOS to write to registers of the processor includes a ResetSystem( ) Runtime Service in a format described in a Unified Extensible Firmware Interface (UEFI) specification, the ResetSystem( ) Runtime Service to include information to cause the BIOS to write to registers of a processor of the computing platform to enable firmware of the processor to flush the persistent data to the persistent memory and then cause the reset of the computing platform.

16. The at least one machine readable medium of claim 12, wherein the persistent memory is configured according to a Compute Express Link (CXL) specification to support a persistent domain and includes non-volatile memory included in a type 2 or a type 3 CXL device configured as host managed device memory (HDM).

17. A computing platform, comprising:
an operating system (OS);
a basic input/output system (BIOS); and
a processor configured to include:
a plurality of registers to include a reset register; and
circuitry configured to execute firmware, the firmware to:
receive an indication that BIOS has set at least one bit in the reset register to indicate persistent data is to be flushed to persistent memory coupled with the computing platform, the BIOS to set the at least one bit responsive to a call from the OS, the call generated by the OS in response to an error event that will require the computing platform to be reset;
cause the persistent data to be flushed to the persistent memory; and
cause the computing platform to be reset.

18. The computing platform of claim 17, wherein the plurality of registers also include one or more crash log registers, and wherein the firmware is directed by the BIOS to gather crash log data from the one or more crash log registers prior to causing the computing platform to be reset.

19. The computing platform of claim 17, wherein the call from the OS includes a ResetSystem( ) Runtime Service in a format described in a Unified Extensible Firmware Interface (UEFI) specification, the ResetSystem( ) Runtime Service to include information to cause the BIOS to set the at least one bit in the reset register to indicate the persistent data is to be flushed to the persistent memory before the reset of the computing platform.

20. The computing platform of claim 17, wherein the persistent memory is configured according to a Compute Express Link (CXL) specification to support a persistent domain and includes non-volatile memory included in a type 2 or a type 3 CXL device configured as host managed device memory (HDM).
